(19) United States
(12) Patent Application Publication
(10) Pub. No.: US 2026/0094082 A1
(43) Pub. Date: Apr. 2, 2026

(54) AUTO PARTS ON DEMAND PLATFORM

(71) Applicant: Joe H. Cummings, College Park, GA (US)

(72) Inventor: Joe H. Cummings, College Park, GA (US)

(21) Appl. No.: 19/194,829

(22) Filed: Apr. 30, 2025

Related U.S. Application Data
(60) Provisional application No. 63/700,151, filed on Sep. 27, 2024.

(51) Int. Cl. G06Q 10/0631; G06Q 10/20; G06Q 30/0601

(52) U.S. Cl. CPC G06Q 10/063112; G06Q 10/20; G06Q 30/0633; G06Q 30/0641

(57) ABSTRACT

The disclosure is directed to a method of obtaining a used vehicle part by a consumer by connecting a consumer with a used vehicle parts uninstallers/parts remover. The method includes the consumer searching on an app on a mobile device, a notebook computer, or a desktop computer for a used vehicle parts uninstaller/remover, displaying on the app a list of registered used vehicle parts uninstaller/parts removers, selecting a used vehicle parts uninstaller/parts remover from a list of registered used vehicle parts uninstallers/parts removers, and making arrangements between the consumer and the used vehicle parts uninstaller/remover to obtain a used vehicle part for the consumer.

### CROSS REFERENCE TO RELATED APPLICATIONS

This application claims priority to U.S. Provisional Application No. 63/700,151 filed Sep. 27, 2024, which is herein incorporated by reference in its entirety.

### BACKGROUND

### Description of the Related Art

Presently, consumers who need to buy used auto parts from a junkyard have to visit the junkyard themselves or find a parts remover/uninstaller to go to the junkyard, find and remove the part, and deliver it to a customer, e.g., a parts vendor.

Accordingly, there is a need for connecting consumers who are in need of an auto part from a junkyard with parts removal/uninstallers who can go to a junkyard, find and remove the part from a vehicle, and deliver it to the consumer.

### SUMMARY DISCLOSURE OF THE INVENTION

This disclosure is to a method of obtaining a used vehicle part by a consumer by connecting a consumer with a used vehicle parts uninstallers/parts remover. The method includes the consumer searching on an app on a mobile device, a notebook computer, or a desktop computer, etc., for a used vehicle parts uninstaller/remover, displaying on the app a list of registered used vehicle parts uninstaller/parts removers, selecting a used vehicle parts uninstaller/parts remover from a list of registered used vehicle parts uninstallers/parts removers, and making arrangements between the consumer and the used vehicle parts uninstaller/remover to obtain the used vehicle part for the consumer.

In another embodiment, a method of obtaining a used vehicle part by a consumer includes the consumer searching on an app on a mobile device, a notebook computer, or a desktop computer for a used vehicle part, displaying a list of used vehicle parts in response to the search, selecting a used vehicle part(s) from the list of used vehicle parts, the consumer then searching on the app for a used vehicle parts uninstaller/remover, displaying on the app a list of registered used vehicle parts uninstaller/parts removers, selecting a used vehicle parts uninstaller/parts remover from the list of registered used vehicle parts uninstallers/parts removers, and making arrangements between the consumer and the used vehicle parts uninstaller/remover to obtain the used vehicle part for the consumer.

The present invention is thus directed to an auto parts part removal/uninstaller platform that can be an on demand outsourcing application that can be used by used auto parts dealers including online auto parts dealers. In one embodiment, the platform can be used as a service provider for auto parts dealers. The platform will connect in real time customers needing an auto part with parts removers/uninstallers who can go to a junkyard, find and remove a part from a vehicle, and deliver it to the customer.

Other features and aspects will be apparent from the following detailed description, and the drawings.

### BRIEF DESCRIPTION OF THE DRAWINGS

FIG. 1 shows a flowchart illustrating an embodiment of the disclosure.

FIG. 2 also shows a flow chart illustrating an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

### MODES FOR CARRYING OUT THE INVENTION

The platform will connect and serve to enable a relationship between customers including used auto parts providers and service providers, e.g., vehicle parts sellers (e.g., junk yards) and uninstallers/parts removers. This will give large auto parts dealers who use the platform a competitive advantage in finding and delivering used auto parts.

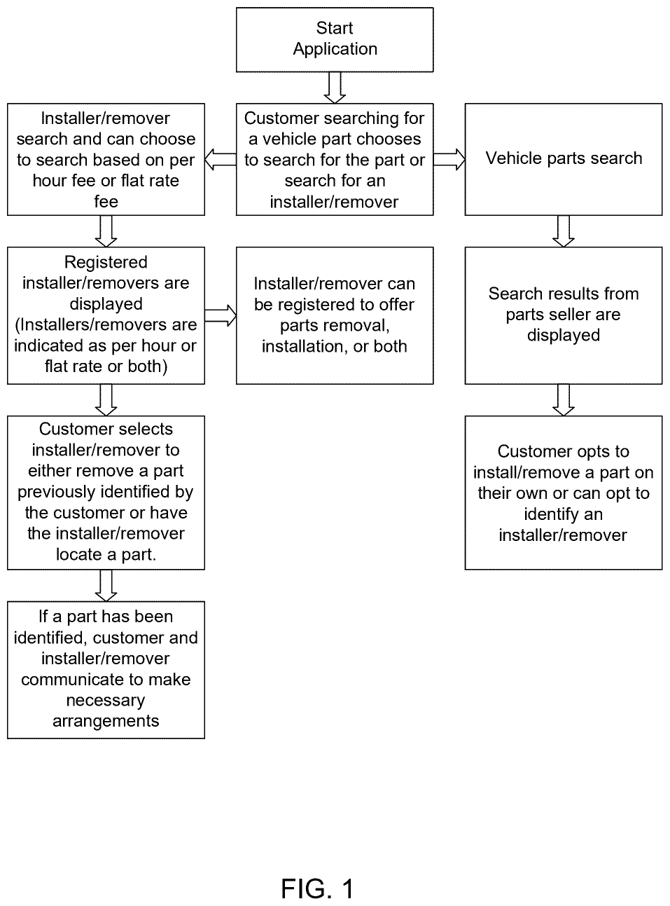

FIG. 1 shows embodiments of the invention. A customer can start the program typically on a computer or mobile device. The user can first choose to either look for a vehicle part themselves or search for an uninstaller/remover. If the customer chooses an uninstaller/remover search, then registered uninstaller/removers will be displayed on the app. The registered uninstaller/removers can be indicated as either per hour or flat rate or both. The customer can then choose to either have an identified part removed, have an uninstaller/remover locate a part as needed, or install a part a customer already has. Once a part is identified, the part remover/uninstaller and customer can communicate through the app to make the needed arrangements. As noted previously, in some cases, the customer can be a commercial auto parts vendor, although any customer or automobile owner who needs a used auto part is contemplated.

Alternatively, the customer can conduct a vehicle parts search themselves. In this case, search results from parts sellers will be displayed. The customer can then choose to install/remove a part on their own or can conduct a further search to identify an uninstaller/remover through the app.

Accordingly, it is contemplated that the platform will match customers with parts sellers and parts, and uninstallers/removers. The platform can run on any mobile device, e.g., smart phone, tablet, smartwatch, or on desktop and laptop computers.

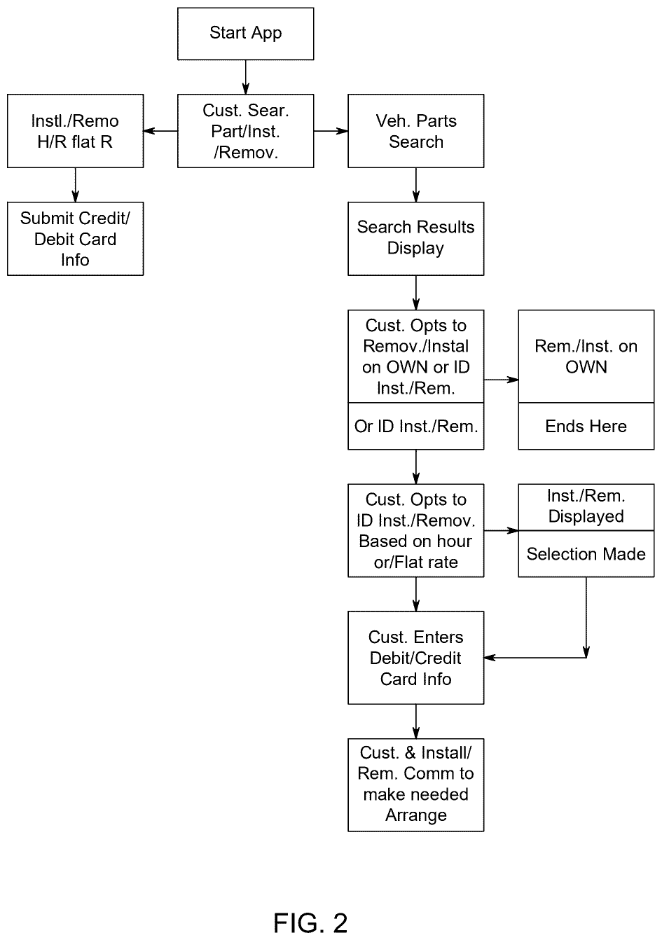

FIG. 2 shows another embodiment of the invention. In this embodiment, the customer starts the app and then in the first step either searches for an auto part or searches for an uninstaller/remover. If search for an uninstaller/remover is chosen, then the options of an hourly rate or flat rate can be provided. The customer can then choose an uninstaller/remover and submit payment information. If a vehicle parts search is chosen, then search results for the auto part will be displayed. The user can then opt to choose a remover/uninstaller or remove/install the part on their own. If the user opts to identify an uninstaller/remover on their own, they can be given the option of choosing an uninstaller/remover based on an hourly rate or a flat rate. Once a flat rate or hourly rate is selected for an uninstaller/remover, payment can be made and arrangements with the uninstaller/remover proceed.

In embodiments, a vehicle parts search can be enabled by an API (application programming interface). In this case, access can be obtained to used vehicle parts seller's databases and inventories. In embodiments, the user can also use the app to find an uninstaller for vehicle parts that they already have. In addition, auto body shops, for example, could use the app to identify uninstallers/removers as well.

The invention can be implemented in digital electronic circuitry, or in computer hardware, firmware, software, or in one or more combinations thereof. The invention can be implemented in a computer program product tangibly embodied in a machine-readable storage device for execution by a programmable processor; and method steps in the invention can be performed by a programmable processor execution a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and optical disks. Any of the foregoing can be supplemented by, or incorporated in, ASICs (application-specific integrated circuits).

A computer system as contemplated herein can include a bus, a processor, a system memory, a read-only memory, a permanent storage device, input devices, and output devices. In some embodiments, the computer system also includes a graphic processing unit (GPU). The bus collectively represents all system, peripheral, and chipset buses that support communication among internal devices of the computer system. For instance, the bus communicatively connects the processor with read-only memory, system memory, and a permanent storage device.

From these various memory units, the processor (also referred to as a central processing unit or CPU) retrieves instructions to execute and data to process in order to execute the processes of the invention. Read-only-memory (ROM) stores static data and instructions that are needed by the processor and other modules of the computer system.

A permanent storage device is a read-and-write memory device. This device is a non-volatile memory unit that stores instruction and data even when the computer system is off. Some embodiments of the invention use a mass-storage device (such as a magnetic or optical disk and its corresponding disk drive) as a permanent storage device. The permanent storage device may be a solid-state storage, a conventional “spinning magnetic pallet” storage (i.e., hard drive), or combinations thereof. Other embodiments may use a removable storage device (such as a USB flash drive or SD Memory Card) as a temporary storage or as the permanent storage device.

System memory is a read and write memory device. The system memory can be a volatile read-and-write memory, such as a random-access memory. The system memory stores at least some of the instructions and data that the processor needs at runtime.

Instructions and/or data needed to perform processes of some embodiments are stored in the system memory, the permanent storage device, the read-only memory, or any combination. For example, the various memory units may contain instructions for processing multimedia items in accordance with some embodiments. From these various memory units, the processor retrieves instructions to execute and data to process in order to execute the processes of some embodiments.

The bus also connects to input and output devices. The input devices enable the user to communicate information and select commands to the computer system. The input devices include, but are not limited to, alphanumeric keyboards, touch panels, cursor controllers and voice command or instruction input. Voice input can include voice commands or instructions input through artificial intelligence (AI) and AI agents and the like. The input devices also include scanners through which an image can be input to the computer system. The output devices display images generated by the computer system. The output devices may include display devices including touch display, such as liquid crystal displays (LCD), light emitting diode (LED), organic light emitting diode (OLED), active matrix organic light emitting diode (AMOLED), electroluminescent displays, cathode ray tubes (CRT), as well as printers, pen plotters, laser printers, ink-jet plotters, and film recorders. More specifically, this includes output displays including state-of-the-art displays and touch displays on cell phones, tablets, laptops and notebook computers, and desktop computers.

Bus can also couple a computer to a network through a network adapter. In this manner, the computer can be a part of a network of computers (such as a local area network (“LAN”), a wide area network (“WAN”), or an Intranet) or a network of networks (such as the Internet). Finally, the computer system in some embodiments also optionally includes a graphics processing unit (GPU). A GPU (also referred to as a visual processing unit or a display processor) is a dedicated graphics rendering device which is very efficient in manipulating and displaying computer graphics. The GPU can be included in a video card or can be integrated into the mother board of the computer system along with the processor. Any or all the components of computer system may be used in conjunction with the invention. However, one of ordinary skill in the art will appreciate that other system configurations may also be used in conjunction with the invention.

### Glossary

The term vehicle as used herein, refers to road vehicles including automobiles, trucks, pick up trucks, vans, sport utility vehicles (SUVs), as well as motorcycles, off road vehicles, and the like.

The term used vehicle part as used herein, generally means a used vehicle part for one of the aforementioned vehicles, e.g., used vehicle or auto parts.

A vehicle parts uninstaller/remover as used herein generally means an individual who will go, for example, to a junkyard, or any other location where a used vehicle part can be obtained, and remove a part from a vehicle, or who can install a part that the customer already has. A preferred embodiment would be obtaining the used vehicle part from a junkyard.

A consumer as used herein would generally mean anyone in need of a used vehicle part for a vehicle, or who needs a vehicle part installed. This can include individual consumers as well as auto parts stores, vehicle dealers including auto dealers, auto repair shops, dealer service centers, and the like.

An app as used herein generally means a software platform, as described above, that can run on a computer, a mobile device, a notebook or laptop computer, a desktop computer, or the like.

A mobile device as used herein generally refers to a smartphone, a tablet computer, a smart watch, or other wearable, or the like. A notebook computer is used in its ordinary sense and includes laptop computers and other portable computing devices. A desktop computer is used in its ordinary sense and includes standard desktop computing devices and the like.

Making arrangements between a consumer and a vehicle parts uninstaller/remover generally includes communications through the app or through text messaging or voice, or any other means necessary, between the consumer and vehicle parts uninstaller/remover to identify and obtain a used auto part. Charging by the hour means typical parts uninstaller/remover charges a set hourly fee for the time necessary to obtain the part. A flat rate would mean the vehicle parts uninstaller/remover charges one single flat fee for the entire job.

A registered vehicle parts uninstaller/remover generally means an uninstaller/remover who has registered with the platform and is certified by the platform as a registered installer/. This would generally include confirming the individual's reliability, expertise, and experience in obtaining and removing used auto parts from vehicles. This would include confirming basic information such as address, age, experience level, and the like. This would also include confirming methods of payment. The registration could generally be comparable to the manner in which drivers are registered with vehicle ride sharing apps as one example. The registered auto parts uninstallers/removers would thus be certified by the platform as competent and reliable. As one example registered uninstallers/removers information necessary to register would contact information including company name (if applicable), driver name, address, cellphone number, email, bank account and payment information, social security number, and password. The information would be confirmed from government issued documents including a state ID or drivers license, passport, social security card, bank statements, etc.

### Example

In one specific example, a used auto part that a consumer is in need of is identified by the consumer on the app to be on a vehicle in a junkyard. The user then searches for, and selects, a used vehicle parts uninstaller/remover. After arranging payment, the used vehicle parts uninstaller/remover then proceeds to the junkyard to locate the vehicle and remove the vehicle part from the vehicle. The vehicle parts uninstaller/remover then proceeds to deliver the part to the consumer. In embodiments, the vehicle parts uninstaller/remover will also install the part on a vehicle for the consumer. As mentioned above, the consumer can be an individual, or an auto parts dealer, auto repair shop, and the like.

While this disclosure includes specific examples, it will be apparent after an understanding of the disclosure of this application has been attained that various changes in form and details may be made in these examples without departing from the spirit and scope of the claims and their equivalents.

1. A method of obtaining a used vehicle part by a consumer by connecting a consumer with a used vehicle parts uninstallers/parts remover(s) comprising:
the consumer searching on an app on a mobile device, a notebook computer, or a desktop computer for a used vehicle parts uninstaller/remover;
displaying on the app on the mobile device, the notebook computer, or the desktop computer, a list of registered used vehicle parts uninstaller/parts removers;
selecting a used vehicle parts uninstaller/parts remover from the list of registered used vehicle parts uninstallers/parts removers;
making arrangements between the consumer and the used vehicle parts uninstaller/remover to obtain the used vehicle part for the consumer.

2. The method of claim 1, further including the consumer entering payment information into the app.

3. The method of claim 1, wherein the list of used vehicle parts uninstaller/parts removers identifies used vehicle parts uninstaller/parts removers that charge by the hour or charge a flat rate.

4. The method of claim 1, wherein the used vehicle parts uninstaller/parts remover installs the used vehicle part on a vehicle for the consumer.

5. A method of obtaining a used vehicle part by a consumer comprising:
the consumer searching on an app on a mobile device, a notebook computer, or a desktop computer for a used vehicle part;
displaying a list of used vehicle parts on the mobile device, the notebook computer, or the desktop computer in response to the search;
selecting a used vehicle part(s) from the list of used vehicle parts on the mobile device, the notebook computer, or the desktop computer;
the consumer then searching on the app on the mobile device, the notebook computer, or the desktop computer, for a used vehicle parts uninstaller/remover;
displaying on the app on the mobile device, the notebook computer, or the desktop computer, a list of registered used vehicle parts uninstaller/parts removers;
selecting a used vehicle parts uninstaller/parts remover from the list of registered used vehicle parts uninstallers/parts removers;
making arrangements between the consumer and the used vehicle parts uninstaller/remover to obtain the used vehicle part for the consumer.

6. The method of claim 5, further including the consumer entering payment information into the app.

7. The method of claim 5, wherein the list of used vehicle parts uninstaller/parts removers identifies used vehicle parts uninstaller/parts removers that charge by the hour or charge a flat rate.

8. The method of claim 5, wherein the used vehicle parts uninstaller/parts remover installs the used vehicle part on a vehicle for the consumer.
